(19) United States
(12) Patent Application Publication
(10) Pub. No.: US 2016/0267770 A1
(43) Pub. Date: Sep. 15, 2016

(54) Systems and Methods for Loose Monitoring of Targets

(71) Applicant: BI Incorporated, Boulder, CO (US)

(72) Inventor: Brad Keays, Manhattan Beach, CA (US)

(21) Appl. No.: 15/066,959

(22) Filed: Mar. 10, 2016

Related U.S. Application Data
(60) Provisional application No. 62/131,250, filed on Mar. 11, 2015.

(51) Int. Cl. G08B 21/22

(52) U.S. Cl. CPC G08B 21/22

(57) ABSTRACT

The present inventions are related to monitoring movement, and in particular to systems and methods for disconnected monitoring of a user location.

### CROSS REFERENCE TO RELATED APPLICATION

The present application claims priority to (i.e., is a non-provisional of) U.S. Pat. App. No. 62/131,250 entitled “Location Monitoring System”, and filed Mar. 11, 2015 by Keays. The entirety of the aforementioned application is incorporated herein by reference for all purposes.

### BACKGROUND OF THE INVENTION

The present inventions are related to monitoring movement, and in particular to systems and methods for disconnected monitoring of a user location.

Large numbers of individuals are currently housed in prisons. This represents a significant cost to society both in terms of housing expense and wasted productivity. To address this concern, house arrest systems have been developed for use by less violent offenders. This allows the less violent offender to be monitored outside of a traditional prison system and allows the offender an opportunity to work and interact to at least some degree in society. The same approach is applied to paroled prisoners allowing for a monitored transition between a prison atmosphere and returning to society. House arrest systems typically require attaching a monitoring device to a monitored individual to verify information sent from the device represents the tracked individual. Use of such devices may be impractical and/or too expensive.

Thus, for there exists a need in the art for more advanced approaches, devices and systems for individual monitoring.

### BRIEF SUMMARY OF THE INVENTION

The present inventions are related to monitoring movement, and in particular to systems and methods for disconnected monitoring of a user location.

This summary provides only a general outline of some embodiments according to the present invention. Many other objects, features, advantages and other embodiments of the present invention will become more fully apparent from the following detailed description, the appended claims and the accompanying drawings and figures.

### BRIEF DESCRIPTION OF THE DRAWINGS

A further understanding of the various embodiments of the present invention may be realized by reference to the figures which are described in remaining portions of the specification. In the figures, similar reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1a is a block diagram illustrating a monitoring system including an ambiguous mobile monitoring device in accordance with various embodiments of the present inventions;

FIG. 1b is a block diagram of the ambiguous mobile monitoring device depicted in FIGS. 1a and 1n accordance with one or more embodiments of the present inventions;

FIG. 2 is a flow diagram showing a method for interaction between an ambiguous mobile monitoring device and a remote monitoring station including scheduling and check-in processes in accordance with some embodiments of the present inventions; and

FIG. 3 is a flow diagram showing a method for interaction between an ambiguous mobile monitoring device and a remote monitoring station including ambiguity reduction check-in processes in accordance with various embodiments of the present inventions.

### DETAILED DESCRIPTION OF THE INVENTION

The present inventions are related to monitoring movement, and in particular to systems and methods for disconnected monitoring of a user location.

Various embodiments of the present inventions provide methods for monitoring a user that include: storing a schedule to an ambiguous mobile monitor device associated with the user; receiving a location data and a user identification data from the ambiguous mobile monitor device in compliance with the schedule via a wireless network, where the user identification information reduces the possibility that the user is not interacting with the ambiguous mobile monitor device; and authenticating the user identification information, wherein authenticating the user identification information indicates that the user is interacting with the ambiguous mobile monitor device.

In some instances of the aforementioned embodiments, the user identification information is a current face image of the user taken using the ambiguous mobile monitor device in accordance with the schedule. In some cases, the methods further include storing a reference face image of the user. In such cases, authenticating the user identification information includes performing a facial recognition comparison between the current face image and the reference face image. In various instances of the aforementioned embodiments, the user identification information is a current print of a digit of the user taken using the ambiguous mobile monitor device in accordance with the schedule. In some cases, the methods further include storing a reference print of the digit of the user. In such cases, authenticating the user identification information includes performing a print recognition comparison between the current print and the reference print. In one or more instances of the aforementioned embodiments, the user identification information is a current sound recording of the user captured using the ambiguous mobile monitor device in accordance with the schedule. In some cases, the methods further include storing a reference sound recording of the user. In such cases, authenticating the user identification information includes performing a voice recognition comparison between the current sound recording and the reference sound recording.

Other embodiments of the present inventions provide methods for monitoring a user that include: receiving a schedule by an ambiguous mobile monitor device associated with the user, wherein the schedule indicates one or more check-in times; prompting the user to perform a check-in based upon the schedule, where the prompt indicates one or more user identification sensors in the ambiguous mobile monitor device to be used in relation to the check-in; receiving location information from a location circuit within the ambiguous mobile monitor device; receiving user identification information from the one or more user identification sensors; and reporting the user identification information and the location information wirelessly to a remote monitoring system.

In some instances of the aforementioned embodiments, the prompt includes a sound output from the ambiguous mobile monitor device. In various instances of the aforementioned embodiments, the prompt includes a movement from the ambiguous mobile monitor device. In one or more instances of the aforementioned embodiments, the prompt includes a visual message provided via a visual display on the ambiguous mobile monitor device. In some cases, the prompt includes instructions for completing the check-in.

Yet other embodiments of the present inventions provide monitoring systems that include: a remote monitoring system and an ambiguous mobile monitor device. The ambiguous mobile monitor device is associated with a user and includes: a user identification circuit operable to generate user identification data corresponding to an individual interacting with the ambiguous mobile monitor device; a location circuit operable to generate a location data for the ambiguous mobile monitor device; and a wireless circuit operable to wirelessly transmit the location data and the user identification data to the remote monitoring system via a wireless network. The remote monitoring system is operable to: generate a check-in schedule for the user and to download the check-in schedule to the ambiguous mobile monitor device via the wireless network; receive the location data and the user identification data from the ambiguous mobile monitor device in compliance with the schedule via the wireless network, where the user identification information reduces the possibility that the user is not interacting with the ambiguous mobile monitor device; and authenticate the user identification information, where authenticating the user identification information indicates that the user is interacting with the ambiguous mobile monitor device.

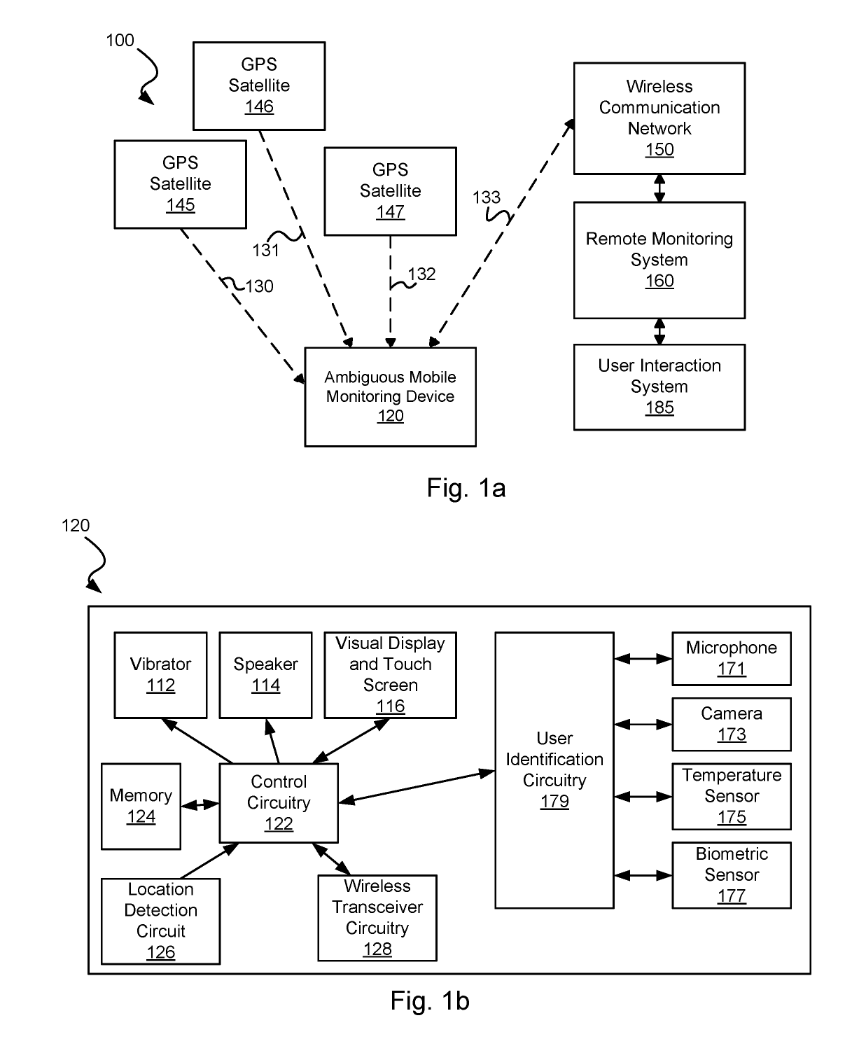

Turning to FIG. 1a, a block diagram illustrates a monitoring system 100 including an ambiguous mobile monitoring device 120 in accordance with various embodiments of the present inventions. Location monitoring system 100 includes: ambiguous mobile monitoring device 120 which in some cases is portable and handheld, and a remote monitoring system 160 wirelessly coupled to ambiguous mobile monitoring device 120 via a wireless communication network 150. Ambiguous mobile monitoring device 120 includes a location sensor that senses the location of the device and generates a location data. The location data may comprise one or more of: global positioning system (“GPS”) data, Assisted GPS (“A-GPS”) data, and Advanced Forward Link Trilateration (“AFLT”) data. Where GPS is used, ambiguous mobile monitoring device 120 receives location information from three or more GPS satellites 145, 146, 147 via respective communication links 130, 131, 132. The aforementioned location data is utilized verify the location of a user associated with ambiguous mobile monitoring device 120 during a ‘check-in’ procedure which is described below in more detail. The ambiguous mobile monitoring device 120 is considered “ambiguous” because it is not attached to the user in a tamper resistant way, but rather is freely severable from the user and thus could be used by persons other than the target. Various processes discussed herein mitigate the aforementioned ambiguity to yield a reasonable belief that information derived from ambiguous mobile monitoring device 120 corresponds to the target.

The location data gathered by ambiguous mobile monitoring device 120 is wirelessly transmitted to remote monitoring system 160 via a wireless communication network 150 accessed via a wireless link 133. Remote monitoring system 160 may be any location, device or system where the location data is received, including by way of non-limiting example: a cellular/smart phone, an email account, a website, a network database, and a memory device. The location data is stored by remote monitoring system 160 and is retrievable therefrom by a monitor, such as a parent, guardian, parole officer, court liaison, spouse, friend, or other authorized group or individual. In this manner, monitor is able to respond appropriately to the detected out-of-bounds activity by a user. Preferably, the monitor is able to retrieve the location data via a user interaction system 185 which may be, but is not limited to, a network connected user interface device communicatively coupled via a network to remote monitoring system 160 and/or directly to ambiguous mobile monitoring device 120 via wireless communication network 150.

Ambiguous mobile monitoring device 120 further includes a user identification sensor operable to generate user identification data for identifying the user in association with the generation of the location data. The user identification data may comprise one or more of: image data, video data, biometric data (e.g. fingerprint, DNA, retinal scan, etc. data), or any other type of data that may be used to verify the identity of the user at or near the time the location data is generated. And the user identification sensor may comprise one or more of: a camera, microphone, heat sensor, biometric data sensor, or any other type of device capable of sensing/generating the aforementioned types of user identification data.

The user identification data is wirelessly transmitted in association with the location data to remote monitoring system 160 via a wireless transmitter communicatively coupled to the user identification sensor. The user identification data is stored in association with the location data by remote monitoring system 160 and is retrievable therefrom by a monitor, such as a parent, guardian, parole officer, court liaison, spouse, friend, or other authorized group or individual. Preferably, the monitor is able to retrieve the location data via a network connected user interface device communicatively coupled—via the network—to remote monitoring system 160 and/or to ambiguous mobile monitoring device 120. The location data may be transmitted to remote monitoring system 160 independent of the user identification data, for example, during a periodic check-in with remote monitoring system 160.

Ambiguous mobile monitoring device 120 may further comprise a memory communicatively coupled to a control unit—which is also communicatively coupled to the location sensor, the identification sensor and the wireless transceiver—for controlling the operations thereof in accordance with the functionalities described herein. As ambiguous mobile monitoring device 120 is portable and handheld, each of the components may be located within, immediately adjacent to, or exposed without, a device housing whose dimensions are such that ambiguous mobile monitoring device 120 as a whole may be discretely carried by the user, for example, within a pocket or small purse.

Remote monitoring system 160 preferably comprises a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the user in accordance with the described embodiments. In particular, the interactive web portals may enable the monitor to retrieve the location and user identification data of one or more users, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website accessible via a software application on a mobile device (e.g. smart phone). The mobile website may be a modified version of the server supported website with limited or additional capabilities suited for mobile location monitoring.

Turning to FIG. 1b, a block diagram of ambiguous mobile monitoring device 120 is shown in accordance with one or more embodiments of the present inventions. Ambiguous mobile monitoring device 120 includes wireless transceiver circuitry 128 that is capable of sending and receiving information via wireless link 133 to/from wireless communication network 150. In addition, ambiguous mobile monitoring device 120 includes a vibrator 112, a speaker 114, and a visual display and touch screen 116. At scheduled times a user of ambiguous mobile monitoring device 120 is alerted of a need to check-in. The schedule of check-in times may be downloaded to a memory 124 by remote monitoring system 160 via wireless link 133. The user may be alerted by one or more of: a visual prompt via visual display and touch screen 116, an audio prompt via speaker 114, and a tactile prompt via vibrator 112. Each of vibrator 112, speaker 114, and visual display and touch screen 116 is communicatively coupled to memory 124 and a control circuitry 122 for controlling the operations thereof. A visual prompt may include, but is not limited to, text, images and/or a combination thereof, or a series of such visual prompts. An audio prompt may include, but is not limited to, one or more different audio prompts, or a series thereof. Each prompt may be stored in memory 124 and retrieved in accordance with the schedule that is also maintained in memory 124. In some embodiments, alerting the user involves a prompt that includes an e-mail or text message generated by remote monitoring system 160 (e.g. the server supported website) and transmitted to the e-mail account or cellular phone number corresponding to ambiguous mobile monitoring device 120. In particular embodiments, such a prompt may include a ‘post’ on the user's ‘wall,’ ‘feed,’ or other social networking privilege. In some embodiments, the prompt may comprise an automated or live phone call to the user.

Ambiguous mobile monitoring device 120 further includes user identification circuitry 179 capable of gathering user identification information from one or more of a microphone 171, a camera 173, a temperature sensor 175, and/or a biometric sensor 177. Microphone 171 is capable of accurately capturing the sound of a user's voice, camera 173 is capable of accurately capturing images including, for example, an image of the user's face, temperature sensor 175 is capable of accurately capturing an ambient temperature around ambiguous mobile monitoring device 120, and biometric sensor 177 is capable of accurately capturing biometric data about the user including, but not limited to, a thumb print or a retinal scan. Under the direction of control circuitry 122, user identification circuitry 179 assembles one or more elements of data gathered by microphone 171, a camera 173, a temperature sensor 175, and/or a biometric sensor 177 into a user identification package which is forwarded to remote monitoring station 160 via wireless transceiver circuitry 128.

Ambiguous mobile monitoring device 120 additionally includes location circuitry 126. Location circuitry 126 may include one or more of, a GPS processing circuit capable of fixing a location of ambiguous mobile monitoring device 120 using GPS data, and an AFLT processing circuit capable of fixing a location of ambiguous mobile monitoring device 120 using AFLT data.

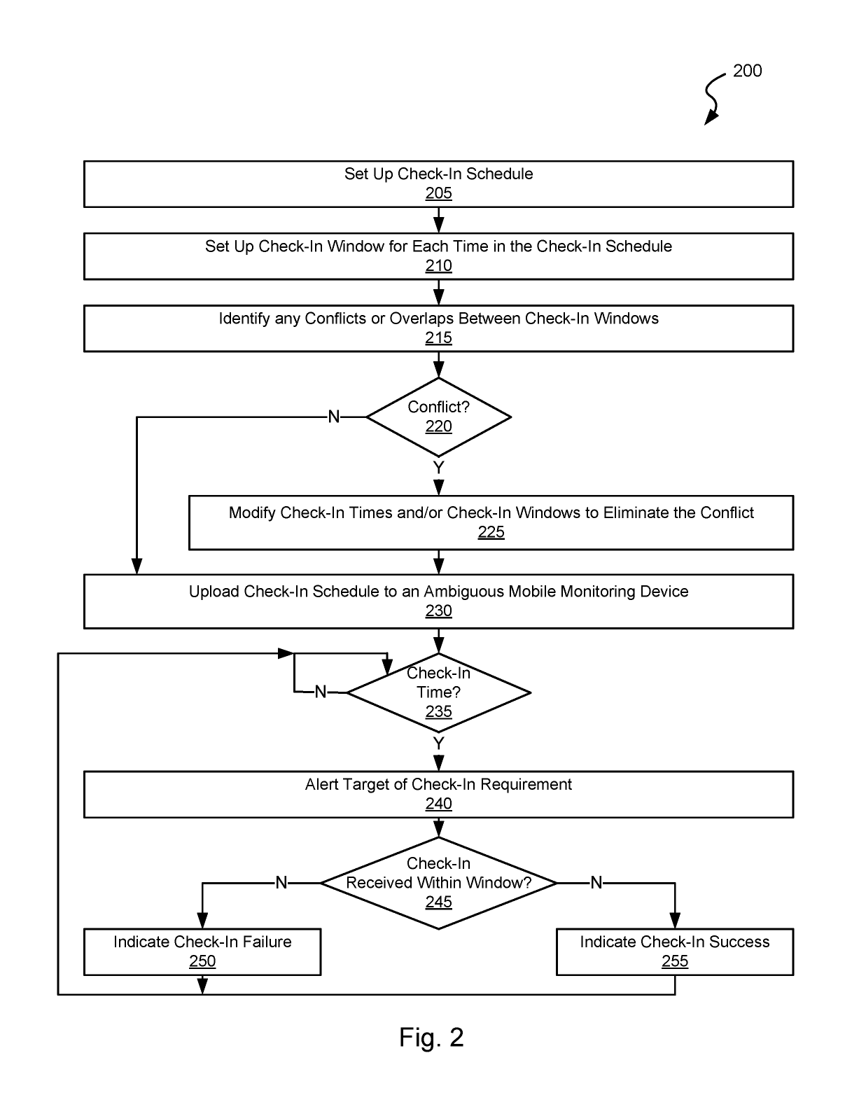

Turning to FIG. 2, a flow diagram 200 shows a method for interaction between an ambiguous mobile monitoring device and a remote monitoring station including scheduling and check-in processes in accordance with some embodiments of the present inventions. Following flow diagram 200, a check-in schedule is set up by a monitor accessing the system via a user interaction device (block 205). The schedule may consist of predetermined check-in periods, random check-in periods, and/or on-demand check-in periods. The monitor sets a predetermined check-in period by selecting a single date/time option for the check-in to occur. The monitor may set multiple predetermined check-in periods by selecting a plurality of single dates/times for the check-in to occur. The monitor sets a random check-in period by selecting a continuous range of date/time options—reflecting the temporal bounds within which the monitor desires the check-in to randomly occur—as well as selecting the number of check-ins the monitor desires to be taken during the random check-in period. As the selection consists of a range, it may be ‘resized’ according to the preference of the monitor. The server system then randomly schedules the desired number of check-in to occur during the set random check-in period. Preferably, if the generated schedule is a periodic schedule (e.g. weekly, bi-weekly, monthly, etc.), the randomly generated check-ins are re-randomized within each set random check-in period for each successive schedule cycle. In addition, or as an alternative, the monitor may also select an on-demand check-in, reflecting a desire to schedule an immediate check-in (or as closely thereto as practical). Preferably, on-demand check-in are not recycled to the next schedule cycle.

Additionally, for each scheduled check-in, there may exist a check-in window, i.e. a period of time from the inception of the check-in period during which the scheduled check-in can be taken by the user before the check-in is considered ‘missed’ by the system. The monitor may set up check-in windows for each time in the check-in schedule or may set up a single check in window that is used in relation with all times in the check-in schedule (block 210). The check-in window may be a default check-in window, or may be generated or otherwise modified by the monitor, preferably via the server supported website. The monitor may select from a plurality of predetermined options for the check-in window, including for example, 30 min, 60 min, 120 min, 180 min, 240 min, or custom duration check-in windows. In some embodiments, the monitor may assign unique check-in windows to the check-in periods. In some embodiments, the check-in window may not exceed a predetermined duration.

Once the check-in schedule and check-in window(s) are received, any conflicts or overlaps between check-in times and windows are identified (block 215). For example, if check-in periods are scheduled for every other hour of the day with check-in windows of 180 minutes, then successive check-in periods would overlap with the check-in windows of the prior check-in period. This is an undesirable result, as it may encourage users to perform a check-in or closely check-ins during the overlapping period, so as to provide the user with more time before the next scheduled check-in in which to go out-of-bounds. This undesirable result may also occur even with merely abutting—rather than overlapping—check-in periods/windows. Consequently, in some embodiments, a ‘conflict’ may be determined where there is an insufficient buffer period between scheduled check-in such that the temptation to go out-of-bounds is not sufficiently mitigated.

It is determined whether there are any conflicts represented in the check-in times and windows (block 220). Where one or more conflicts are identified (block 220), one or more of the check-in times or check-in windows are modified to resolve the identified conflict(s) (block 225). This conflict resolution may be done automatically or under direction of the monitor. The selected schedule is then uploaded from the remote monitor station to the ambiguous mobile monitoring device (block 230).

During operation of the ambiguous mobile monitoring device it is determined whether the schedule indicates a check-in time (block 235). Where a check-in time is indicated (block 235), the user (i.e., the expected user of the ambiguous mobile monitoring device) is alerted of the check-in requirement (block 240). This may be done using one or more of a speaker, vibrator, or visual display included in the ambiguous mobile monitoring device. The alert may include instructions indicating to the user a time limit for checking in and what user identification information is to be provided as part of the check-in. For example, the alert may indicate that the user has 30 minutes to check-in and must take a picture of their face using the camera in the ambiguous mobile monitoring device. As another example, the alert may indicate that the user has 20 minutes to check-in and must take a thumb print using the biometric circuitry included in the ambiguous mobile monitoring device. As yet another example, the alert may indicate that the user has one hour to record a message included in the alert using the microphone in the ambiguous mobile monitoring device. As yet another example, the alert may indicate that the user has one 20 minutes to both record a message included in the alert using the microphone in the ambiguous mobile monitoring device and take a face shot using the camera included in the ambiguous mobile monitoring device.

It is determined whether the required check-in information was received by the ambiguous mobile monitoring device within the expected window of time (block 245). If the required information is not received (block 245), a check-in failure is indicated (block 250). When such a check-in failure is indicated, a message is sent from the ambiguous mobile monitoring device to the remote monitoring station that includes recent location information for the ambiguous mobile monitoring device and an indication of the check-in failure. Alternatively, if the required information is not received (block 255), a check-in success is indicated. When such a check-in success is indicated, a message is sent from the ambiguous mobile monitoring device to the remote monitoring station that includes recent location information for the ambiguous mobile monitoring device and the gathered user identification information (i.e., a subset of the required check-in information).

In some cases, all data gathered by the ambiguous mobile monitoring device is time stamped. Such time stamp data may be generated from a clock in association with the administered check-in. The timestamp data reflects the time and/or date in which the check-in was administered, and may be transmitted to the remote monitoring system in association with the check-in. In some embodiments, the remote monitoring system operates according to a default time, e.g. UTC time, while the location monitoring device operates according to the clock time. In some embodiments, during a period of connectivity, the clock time may be reset to match the default time. In such circumstances, any time stamp data transmitted prior to the reset may be prorated to generate a modified timestamp reflecting the date/time of the administered check-in according to the default time. For example, when a periodic ‘check-in’ occurs and it is determined that the clock time is, for example, 5 seconds behind the default time, the timestamp data for the associated check-in transmitted at the ‘check-in’ is modified by that 5 second discrepancy to reflect the time of the administered check-in according to the default time. In this manner, the timestamp data for each administered check-in stored by the monitoring station is according to a uniform date/time standard, e.g. the default time.

The location and user identification information provided by the ambiguous mobile monitoring device to the remote monitoring system may be utilized by the remote monitoring system to generate one or more reports based thereon. Such reports may include the data (and other data) from one or more administered and/or scheduled check-ins. In some embodiments, the reports are generated automatically at specified intervals, e.g. daily, weekly, monthly, per check-in. The generated reports may be accessed by the monitor via the interactive web portal to the server supported website, whereby the monitor may review one or more reports online. In some embodiments, the generated reports may be emailed or text messaged to the email account or cellular phone of the monitor, respectively. In some embodiments, the generated reports may comprise a ‘post’ on the user's ‘wall,’ ‘feed,’ or other social network account.

In some embodiments, the system provides a ‘text-message’ opt-in option. When, through registration, a mobile number is added or updated on the website, the system identifies if the number has previously been blacklisted or confirmed. If it has not been either, the system texts an invitation to that number to opt-in to receive text-message alerts and/or reports. If the monitor (or user) responds to the invite with a “SUBSCRIBE” response, the number is marked as confirmed and from that point forward is able to receive text messages from the system. At any time, the monitor (or user) may text “STOP” to unsubscribe.

The web portal may contain functionality allowing the monitor to: add/delete/edit monitor contact information; select for each monitor contact the circumstances (e.g. missed/failed check-ins, daily, weekly, monthly) and methods (e.g. text or email) in which the monitor will receive automated reports and/or alerts. Each of these functionalities, as well as the functionalities of other web portals may be implemented in part or in whole via monitor/user fillable fields, drop down menus and/or selectable icons.

As discussed herein, the generated reports may include more or less information than what is described herein, but which is nonetheless apparent to one of ordinary skill in the art as desirable for effective monitoring. Accordingly, in some embodiments, the generated report may comprise an alert, which is a report with limited information transmitted to the monitor so that the monitor may be apprised of an important event such as a missed/failed check-in. The alert, for example, may include a text message that identifies the user and the important event. Upon receiving the alert, the monitor may access the monitoring station (e.g. the server supported website) and review the generated report having all the requested information. As with the previously described reports, it is contemplated that the monitor may customize his/her preferences regarding the alerts not only with regards to the information provided, but as to how the alerts are transmitted and/or displayed.

In some circumstances, the monitor may be responsible for monitoring a plurality of users. In such circumstances, the teachings described herein are applicable to the plurality of users. Further, the generated report may be a combined report, viewable via the server supported website, containing hyperlinks or other access to the reports of each individual user.

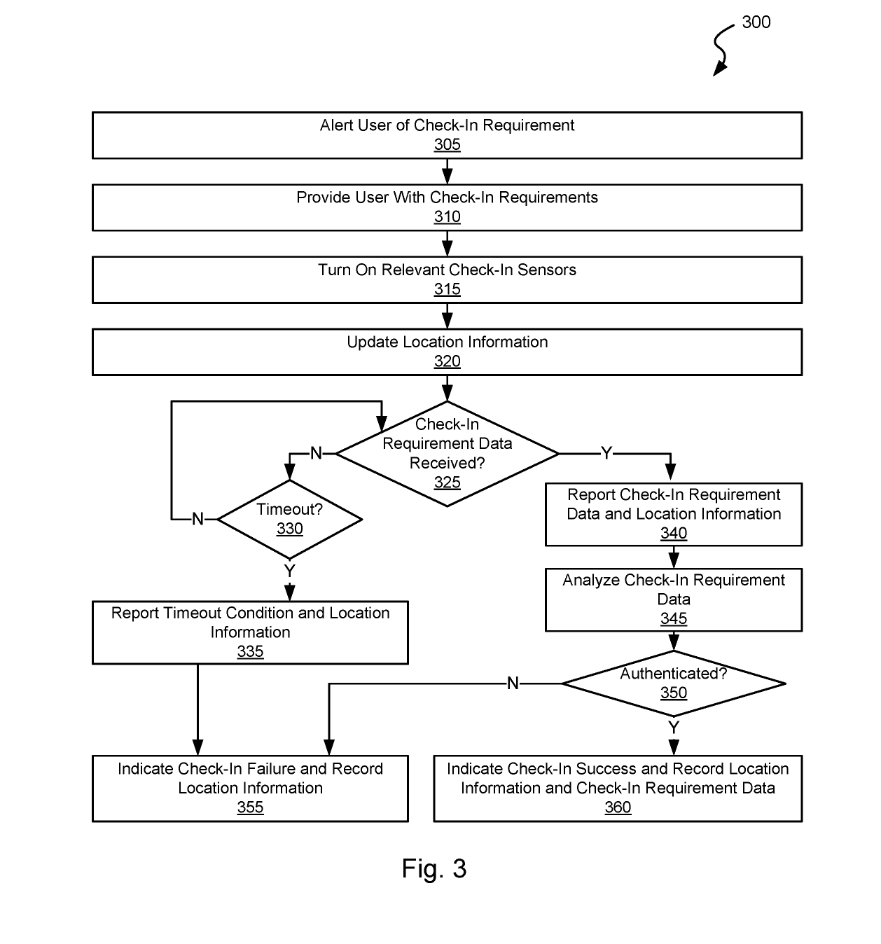

Turning to FIG. 3, a flow diagram 300 shows a method for interaction between an ambiguous mobile monitoring device and a remote monitoring station including ambiguity reduction check-in processes in accordance with various embodiments of the present invention. Following flow diagram 300, a user is alerted of a check-in requirement (block 305). This alert may be generated locally by an ambiguous mobile monitoring device based upon a previously downloaded schedule. This alert may be done using one or more of a speaker, vibrator, or visual display included in the ambiguous mobile monitoring device. In addition, the user is notified of the check-in requirements (block 310). The alert may include instructions indicating to the user a time limit for checking in and what user identification information is to be provided as part of the check-in. For example, the alert may indicate that the user has 30 minutes to check-in and must take a picture of their face using the camera in the ambiguous mobile monitoring device. As another example, the alert may indicate that the user has 20 minutes to check-in and must take a thumb print using the biometric circuitry included in the ambiguous mobile monitoring device. As yet another example, the alert may indicate that the user has one hour to record a message included in the alert using the microphone in the ambiguous mobile monitoring device. As yet another example, the alert may indicate that the user has one 20 minutes to both record a message included in the alert using the microphone in the ambiguous mobile monitoring device and take a face shot using the camera included in the ambiguous mobile monitoring device.

The relevant check-in sensors within the ambiguous mobile monitoring device are turned on (block 315), and the location information for the ambiguous mobile monitoring device is updated (block 320). It is determined whether the required check-in information was received by the ambiguous mobile monitoring device (block 325). If the required information is not received (block 325), it is determined if a timeout condition occurred (block 330). Where the timeout condition has not been met, it is again determined whether the required check-in information was received by the ambiguous mobile monitoring device (block 325). Where, on the other hand, the timeout condition does occur (block 330), the timeout condition and the location information are transmitted from the ambiguous mobile monitoring device to the remote monitoring system (block 335). Alternatively, where the required check-in information was received by the ambiguous mobile monitoring device (block 325), the check-in information and the location information are transmitted from the ambiguous mobile monitoring device to the remote monitoring system (block 340).

The remote monitoring system performs various processes based upon the received information. In particular, where a timeout condition was reported by the ambiguous mobile monitoring device (block 335), the remote monitoring system indicates a check-in failure and records the location provided from the ambiguous mobile monitoring device (block 355). Alternatively, where the required check-in information was received from the ambiguous mobile monitoring device (block 340), the check-in information is analyzed by the remote monitoring system to determine whether it is authentic (block 345). This may include, for example, comparing a face picture of the user received as part of the user identification information with a reference photo of the user maintained in the remote monitoring system using facial recognition software. As another example, this may include comparing a thumb print received as the user identification information with a reference thumb print maintained in remote monitoring system.

Based upon the aforementioned analysis (block 345), it is determined whether the individual providing the user identification information via ambiguous mobile monitoring device is the user expected to be associated with the device (i.e., the target of the monitoring) (block 350). Where the user is authenticated as the expected user (block 350), the remote monitoring system indicates a check-in success and records the location information and user identification received as part of the check-in (block 360). Alternatively, where the user is not authenticated as the expected user (block 350), the remote monitoring system indicates a check-in failure and records the location provided from the ambiguous mobile monitoring device (block 355).

Some embodiments implement the ambiguous mobile monitoring device as part of a smart phone or other personal smart device, such as a PDA or the like. In such a system, a schedule is created according to which the check-ins are to be administered. As detailed above, the schedule may be generated and/or stored by the server system based on input provided by the monitor. Reference data is provided to the remote monitoring system by one or more of the monitor, the user, and the ambiguous mobile monitoring device. The reference data may include reference user identification information data against which to compare check-in associated user identification information data. For example, the reference user identification information data may include an image of the user against which facial recognition software may be used to compare check-in image data of the user. For example, the reference user identification information data may include a reference thumb print or other reference biometric data against which to compare the check-in associated user identification information data. The reference data may further include reference location data against which to compare check-in associated location data to determine whether the user is out-of-bounds. The reference location data may be, for example, a defined distance vector (e.g., a predetermined radius) from a geographic location—and out-of-bounds may be defined as either within or without the distance vector. The reference data is retrievably stored by the monitoring station, which utilizes it as described herein to compare against check-in associated data, thereby determining the appropriate check-in result (e.g., missed, failed, passed).

Subsequently, the schedule may be accessed by the monitoring device so as to prompt the user to initiate scheduled check-ins. The schedule may consist of predetermined check-in periods, random check-in periods, and/or on-demand check-in periods. For example, a bump reminder may appear on the smart phone of the user prompting the scheduled check-in.

In response to the schedule, the user of the ambiguous mobile monitoring device administers the check-in. This occurs by the user engaging the user identification information sensor(s) so as to generate the user identification information data. For example, for a retinal scan or facial recognition sensing, the user may orient the smart phone camera to capture his/her eye or face. For example, for a thumbprint or other biometric scan, the user may place his thumbprint onto the touchscreen of the smart phone to be read thereby.

The location data is more or less contemporaneously generated with the user identification information data so as to guard against forgery. In some embodiments, the user identification information data generation may require that the user hold the engagement of the user identification information sensor (e.g., hold his/her thumb in place, or hold the camera focused on his/her face) for a predetermined period while the location data is being generated.

Once generated, the location data and the user identification information data are transmitted from the ambiguous mobile monitoring device to the remote monitoring system in accordance with the schedule, as described above. When the data associated with the scheduled check-in is not received by the remote monitoring system in accordance with the schedule, the scheduled check-in may be associated with a ‘missed’ result. When the data associated with the scheduled check-in fails to match the reference data, the scheduled check-in may be associated with a ‘failed’ result.

The location and/or user identification information data and/or results may be utilized by the system to generate one or more reports based thereon. Such reports may include the data (and other data) from one or more administered and/or scheduled check-ins. The generated reports may be accessed by the monitor via the interactive web portal to the server supported website, whereby the monitor may review one or more reports online. In some embodiments, the generated reports may be e-mailed or text messaged to the e-mail account or cellular phone of the monitor, respectively.

Additional details of the aforementioned features and others in the context of sobriety monitoring may be found in U.S. Pat. No. 8,707,758, issued on Apr. 29, 2014; U.S. Pat. No. 8,381,573, issued on Sep. 15, 2010; and U.S. application Ser. No. 13/274,553, filed on Oct. 17, 2011, the entire disclosures and contents of which are herein incorporated by reference in their entirety. Additional details of these features and others may also be found in the figures filed herewith, the entire disclosure and contents of which is herein incorporated by reference in its entirety.

In conclusion, the present invention provides for novel systems, devices, and methods for monitoring individuals and/or assets. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for monitoring a user, the method comprising:
storing a schedule to an ambiguous mobile monitor device associated with the user;
receiving a location data and a user identification data from the ambiguous mobile monitor device in compliance with the schedule via a wireless network, wherein the user identification information reduces the possibility that the user is not interacting with the ambiguous mobile monitor device; and
authenticating the user identification information, wherein authenticating the user identification information indicates that the user is interacting with the ambiguous mobile monitor device.

2. The method of claim 1, wherein the user identification information is a current face image of the user taken using the ambiguous mobile monitor device in accordance with the schedule.

3. The method of claim 2, wherein the method further comprises:
storing a reference face image of the user, and
wherein authenticating the user identification information includes performing a facial recognition comparison between the current face image and the reference face image.

4. The method of claim 1, wherein the user identification information is a current print of a digit of the user taken using the ambiguous mobile monitor device in accordance with the schedule.

5. The method of claim 4, wherein the method further comprises:
storing a reference print of the digit of the user, and
wherein authenticating the user identification information includes performing a print recognition comparison between the current print and the reference print.

6. The method of claim 1, wherein the user identification information is a current sound recording of the user captured using the ambiguous mobile monitor device in accordance with the schedule.

7. The method of claim 6, wherein the method further comprises:
storing a reference sound recording of the user, and
wherein authenticating the user identification information includes performing a voice recognition comparison between the current sound recording and the reference sound recording.

8. A method for monitoring a user, the method comprising:
receiving a schedule by an ambiguous mobile monitor device associated with the user, wherein the schedule indicates one or more check-in times;
prompting the user to perform a check-in based upon the schedule, wherein the prompt indicates one or more user identification sensors in the ambiguous mobile monitor device to be used in relation to the check-in;
receiving location information from a location circuit within the ambiguous mobile monitor device;
receiving user identification information from the one or more user identification sensors; and
reporting the user identification information and the location information wirelessly to a remote monitoring system.

9. The method of claim 8, wherein the prompt includes a sound output from the ambiguous mobile monitor device.

10. The method of claim 8, wherein the prompt includes a movement from the ambiguous mobile monitor device.

11. The method of claim 8, wherein the prompt includes a visual message provided via a visual display on the ambiguous mobile monitor device.

12. The method of claim 8, wherein the prompt includes instructions for completing the check-in.

13. The method of claim 8, wherein the user identification sensors includes a camera, and wherein the user identification information is a facial image of the user.

14. The method of claim 8, wherein the user identification sensors includes a microphone, and wherein the user identification information is a sound recording of the user.

15. The method of claim 8, wherein the user identification sensors includes a biometric sensor, and wherein the user identification information is a biometric attribute of the user.

16. A monitoring system, the monitoring system comprising:
a remote monitoring system; and
an ambiguous mobile monitor device associated with a user, wherein the ambiguous mobile monitor device includes:
a user identification circuit operable to generate user identification data corresponding to an individual interacting with the ambiguous mobile monitor device;
a location circuit operable to generate a location data for the ambiguous mobile monitor device; and
a wireless circuit operable to wirelessly transmit the location data and the user identification data to the remote monitoring system via a wireless network; and
wherein the remote monitoring system is operable to:
generate a check-in schedule for the user and to download the check-in schedule to the ambiguous mobile monitor device via the wireless network;
receive the location data and the user identification data from the ambiguous mobile monitor device in compliance with the schedule via the wireless network, wherein the user identification information reduces the possibility that the user is not interacting with the ambiguous mobile monitor device; and
authenticate the user identification information, wherein authenticating the user identification information indicates that the user is interacting with the ambiguous mobile monitor device.

17. The monitoring system of claim 16, wherein the user identification information is a current print of a digit of the user taken using the ambiguous mobile monitor device in accordance with the schedule, and wherein the remote monitoring system is further operable to:
store a reference print of the digit of the user, and
wherein authenticating the user identification information includes performing a print recognition comparison between the current print and the reference print.

18. The monitoring system of claim 16, wherein the user identification information is a current sound recording of the user captured using the ambiguous mobile monitor device in accordance with the schedule, and wherein the remote monitoring system is further operable to:
store a reference sound recording of the user, and
wherein authenticating the user identification information includes performing a voice recognition comparison between the current sound recording and the reference sound recording.

19. The monitoring system of claim 16, wherein the user identification information is a current face image of the user taken using the ambiguous mobile monitor device in accordance with the schedule, and wherein the remote monitoring system is further operable to:
store a reference face image of the user, and
wherein authenticating the user identification information includes performing a facial recognition comparison between the current face image and the reference face image.

20. The monitoring system of claim 16, wherein the user identification circuit includes one or more sensors selected from a group consisting of: a camera, a microphone, a temperature sensor, and a biometric sensor.
